(19) United States
(12) Patent Application Publication
(10) Pub. No.: US 2013/0078966 A1
(43) Pub. Date: Mar. 28, 2013

(54) SYSTEM AND METHOD FOR NOTIFYING THE USER OF A MOBILE PHONE THE STATUS OF AN ORIGINATED PHONE CALL

(71) Applicant: Ting-Mao Chang, Los Altos, CA (US)

(72) Inventor: Ting-Mao Chang, Los Altos, CA (US)

(21) Appl. No.: 13/614,414

(22) Filed: Sep. 13, 2012

Related U.S. Application Data
(60) Provisional application No. 61/538,131, filed on Sep. 23, 2011.
(60) Provisional application No. 61/666,063, filed on Jun. 29, 2012.

(51) Int. Cl. H04W 4/16

(52) U.S. Cl. 455/414.1

(57) ABSTRACT

A system and a method for notifying the user of a mobile phone the status of an originated phone call. The notification prevents user from using the earpiece speaker of the phone such that the user's head can be away from the mobile phone when establishing connection and reducing absorption of the electromagnetic radio wave, which may cause the risk of brain cancer, especially for young children. The notification is then stopped by user's behavior when starting to talk, which is less distraction than traditional way of making a call.

### BACKGROUND

1. Field of Invention

This invention discloses a system and method for a mobile phone to notify users the status of an originated phone call and more particularly relates to making a phone call with lower distraction and lower electromagnetic radiation exposure to user.

2. Description of Prior Art

When users initiate or make an out-going phone call, they usually put the phone close to their ear to listen to the returning ring tone or music coming from the other end of the phone call to tell if the called party answered the phone or not. Some mobile phone may display a text message, “calling”, on the displayer and then display another message, “connected”, when the other end answers the phone call. However, people seldom look at the text message to determine the connection status because it is not only inconvenient but also distracting. It prevents users from doing other activities, such as walking on the street or watching the surrounding. Therefore, users are forced to listen to the earpiece and potentially absorb more electromagnetic radiation than necessary.

For faster and reliable connection, mobile phones usually boost up the wireless signal strength to establish the communication and lower signal strength after establishing the connection. However, raising wireless signal strength causes higher electromagnetic radiation emission. According to the recent World Health Organization report, the electromagnetic radiation emission from mobile phones may cause the risk of brain cancer, especially for young children.

For the health reason, people are recommended to use wire or wireless earset while talking or listening to the phone. However, many people don't like to use it. Most of the phones, such as feature phone or smart phone, contain a loud speaker, in addition to the earpiece speaker, for the use in speaker phone mode or listening to music. Alternatively, users can use the loud speaker mode of the phone to avoid putting the phone close to the ear, so the receiving voice from the other end of conversation is speaking out loudly from the speaker. For privacy concern, most of the users don't like to use the speaker mode in public place. So, users need to manually switch back to using earpiece speaker of the phone when phone call has been established and then start the conversation. This is very inconvenient to the users. To notify a user with a speaker is neither good nor effective if the user is in a very noisy or very quiet environment.

### SUMMARY OF THE INVENTION

A system and method for mobile phone to notify user the status of an originated phone call is provided. With the status notification, the user can avoid listening to the earpiece speaker of the phone to tell whether the connection is established or not. The notification can be applied before or after the call setup is finished. In the preferred embodiment of the present invention, the present invention notifies the user by the vibration after the call setup is finished. The status notification uses one or more general notification device, such as ring tone buzzer, loud speaker, light emitter, etc. Then, the user starts the conversation in response to the notification. The present invention automatically stops the notification when detects user's intention to talk. The intention includes one or more activities caused by user starting the conversation. The activity includes moving the phone, rotating the phone, talking to the phone, touching a button, or user's face in proximity to the phone, etc. If the called party reject or did not answer the call, the preferred embodiment of the present invention might further generate a failure notification that is different from the notification if call setup success. For accurately detect user's intent to talk, yet another embodiment of the present invention further detects the pre-existing said activities before the notification. The embodiment dynamically reduces the impact of pre-existing activity when determining user's intent to talk, which is the notification stop condition. For example, automatically switch from using accelerator sensor to using proximity sensor if user is running during call setup.

In yet another embodiment of the present invention, the mobile phone automatically decides the notification device for notifying user the setup status of an originated phone call based on the ambient conditions. The ambient condition, for example, is quietness, darkness, temperature, proximity to human body etc. Actually, the method to decide the notification device can be applied to both in-coming call and out-going call setup status notification.

### DRAWING FIGURES

A system and method for mobile phone to notify the user the status of an originated call to avoid distraction to user or electromagnetic radiation absorption to user is provided. In the following description, for purpose of explanation, numerous of specific details are set forth in order to provide a thorough understanding of the present invention.

FIG. 1 shows the components in a general mobile phone.

FIG. 2 shows the mobile phone connecting to a base station subsystem, a mobile switch center, and then to the called party's phone though a phone network.

FIG. 3 shows the call setup process for originating a phone call in a GSM mobile network.

FIG. 4 shows the notification work flow of the present invention.

### DESCRIPTION

As used herein, originating a phone call refers to making an out-going call from a phone.

### The System

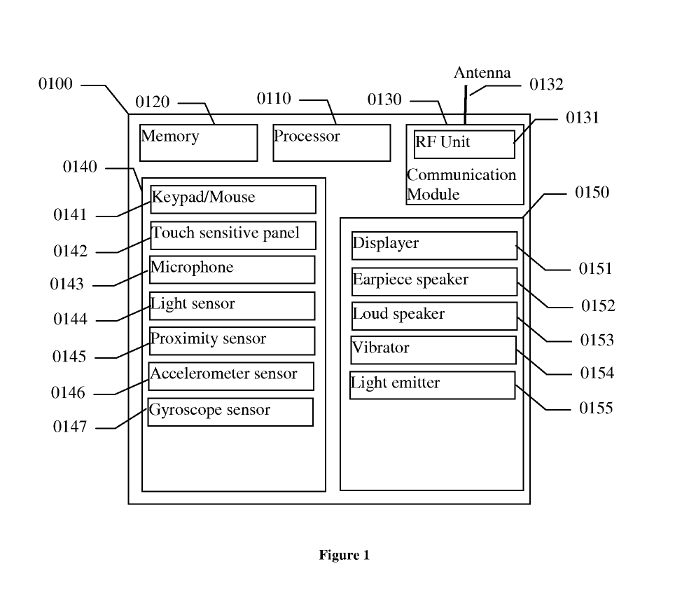

FIG. 1 illustrates an example of said mobile phone 0100 for originating a phone call in accordance with some embodiments of the present invention. The system 0100 is generally implemented using any conventional general-purpose mobile phone having conventional mobile phone components, including one or more processors 0110, program memory 0120, one or more communication module 0130, one or more input devices 0140, and one or more output devices 0150. For description purpose, several I/O devices commonly found in smart mobile phone are shown in input devices 0140 and output devices 0150. The input devices 0140 include one or more of the following devices, keypad or mouse pointer 0141, touch sensitive panel 0142, microphone 0143, light sensor 0144, proximity sensor 0145, accelerometer sensor 0146, gyroscope sensor 0147, etc. The output devices 0150 include one or more of the following devices, such as liquid crystal displayer (LCD) 0151, earpiece speaker 0152, loud speaker or ring buzzer 0153, vibrator 0154, light emitter diode (LED) 0155, etc. The communication module 0130 includes one or more radio frequency (RF) unit 0131 and one or more antennas 0132. The system 0100 includes a dialer for taking the phone number of the called party from user. The dialer is usually implemented in a software application and uses the keypad 0141, touch sensitive panel 0142, or microphone 0143 as input device. In some embodiments, system 0100 is a basic mobile phone or special purposed mobile phone that may omit one or more components found in smart mobile phone, for example keypad, ring buzzer, proximity sensor, etc. In general, any mobile phone may be used in various embodiments of the present invention.

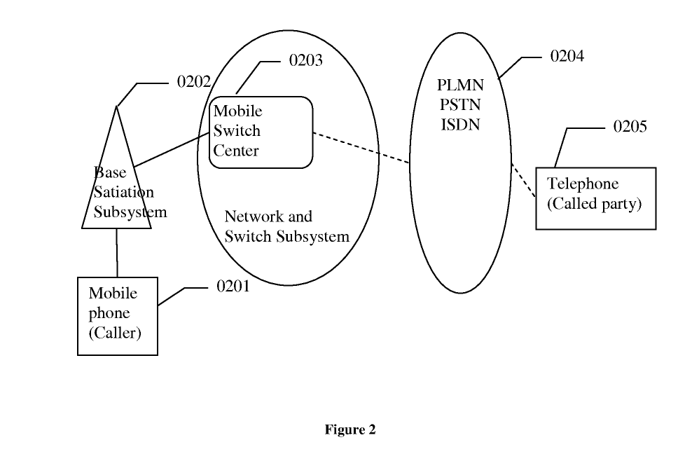

The present invention could be used in any phone application or system, such as CDMA, 3G, LTE, or voice over internet protocol (VOIP), etc. FIG. 2 illustrates the general GSM mobile network architecture. The mobile phone 0201, i.e. mobile station, is connected to a base station subsystem (BSS) 0202, which in turn connects to a mobile switch center (MSC) 0203, which is in a Network Switch Subsystem. The mobile switch center might route the call to other phone network 0204, such as the public switched telephone network (PSTN), another public land mobile network (PLMN), etc. Then, the phone network, a land line network or other mobile networks, eventually connects to the phone 0205, i.e. the receiving party of the call.

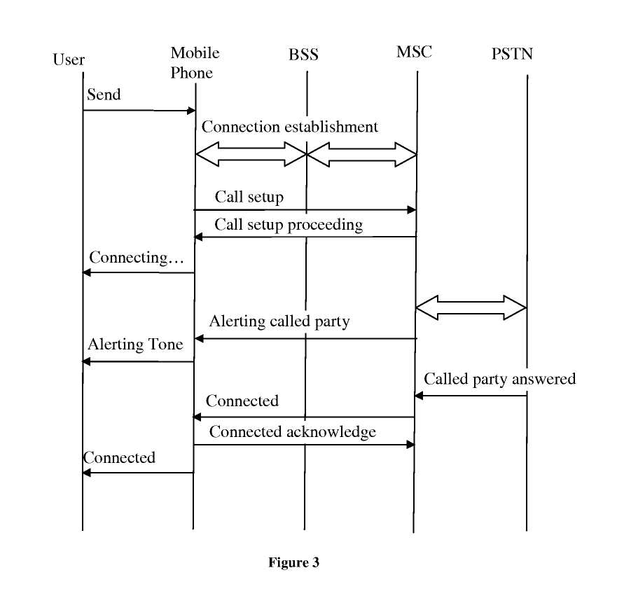

FIG. 3 illustrates a call setup process of a mobile originated call in a GSM mobile network. A dialer receives the phone number or an ID of a called party from user. The dialer then sends the phone number to the communication module 0130 to originate a phone call to the called party. Through the communication module 0130, the system 0100 first establishes the connection to the base station subsystem (B SS) and then to the mobile switch center (MSC). Then, the system 0100 sends information, including the called party's phone number or ID, to MSC for setting up the call. The MSC acknowledges the receipt of the call setup request. The system 0100 then displays “connecting . . . ” or “dialing . . . ” to user. And, the MSC routes the call to the PSTN or another PLMN. PSTN or the PLMN then alerts the called party and replies to MSC that the called party has been alerted. The MSC in turn tells system 0100 that the called party has been alerted. The system 0100 then produces alerting tone in the earpiece of the phone. When the called party answers the call, the PSTN or the PLMN informs MSC and MSC informs system 0100. The system 0100 then displays “connected” to the user. During of the call setup, the call might be dropped because the connection fails or the called party rejects the call. Therefore, the call setup process could end up in call success or call fail.

### Operation Flow

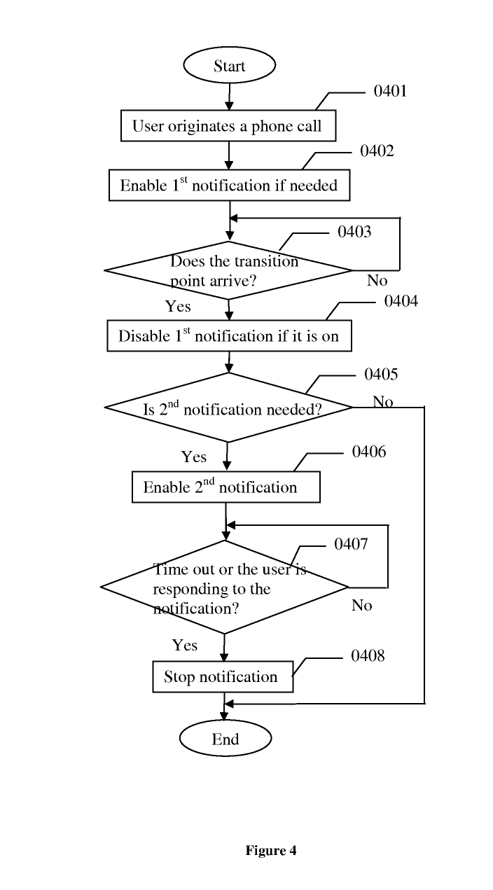

FIG. 4 illustrates the notification process for an originated call by the system 0100, according to some embodiments of the present invention. To notify user the setup status, the notification could be generated during the call setup process, after the call setup process, or both. In another embodiment, an automatic answering machine can answer the call if the called party did not answer the call within certain amount of time. A voice message will be send to the mobile phone to prompt the caller to leave a message or to hang up before the call setup process is done. Since most of the current telephone network system didn't notify the caller's phone before sending the answer machine prompt message in voice. User will miss the prompt message if the caller did not listen to the ear piece. The preferred embodiment of the present invention is designed to notify user in response to the start of the answer machine prompt message, the end of call setup process, or both. Therefore, the user will not miss the prompt message if the telephone network system sends a signal to caller's phone to indicate the answer machine prompt message, and prefer to be sending before the prompt message.

The notification process starts from stage 0401.

In stage 0401, the user inputs or selects a phone number of the called party through a dialer. The dialer sends the phone number to the communication module to originate the phone call to the called party. Then, the system 0100 starts the call setup process as previously described. While the system 0100 is setting up the call, the notification process goes to stage 0402.

In the stage 0402, enable the first notification if it is needed. The first notification might be generated continuously or periodically during the call setup process. Then, go to stage 0403. It's user's option to enable the first notification or not.

In stage 0403, wait for either the end of the call setup process or the start of the answer machine prompt message. As used herein, a transition point refers to either the end of call setup process or the start of the answer machine prompt message. The end of call setup process includes call success or call fails. If the transition point occurs, go to stage 0404.

In stage 0404, stop the first notification if it is on. Go to stage 0405.

In stage 0405, go to stage 0406 if the second notification is needed. Otherwise, go to 0409. It's user's option to enable the second notification or not.

In stage 0406, start the second notification and go to stage 0407. The second notification might be generated continuously or periodically during after the transition point. In the preferred embodiment of the present invention, the second notification should be distinguishable from the first notification. In another embodiment of the present invention, the type of second notification is further determined based on the call setup successes or fails. It will be described later.

In stage 0407, wait for a signal to stop the second notification. If the signal occurs, go to stage 0408. The signal to stop the notification is generated in response to one or more stop conditions. The stop condition includes moving the phone, touching a touch sensitive device of the phone, speaking to the phone, changing the orientation of the phone, moving the phone to the proximity of the user's ear, or stopping by a time-out mechanism, etc. Sensors in the system 0100 are used to detect said stop conditions. For example, an accelerometer can detect the phone movement related activity, such as, acceleration or gesture, etc. A microphone can detect the sound related activity, such as user's volume or the volume change, etc. A proximity sensor can detect the user's face or ear in proximity to the phone. A gyroscope can detect the orientation related activity, such as the orientation of the phone or the change of orientation. A button or touch screen can detect user's touching or pressing. The time-out mechanism is to prevent the user from prolonging the notification duration caused by ignorance. The time-out interval can be a default value or a user specified value. In another embodiment of the present invention, different time-out intervals may be applied for distinguishing the call is connected or is dropped.

In stage 0407, stop the second notification and then go to stage 0408.

In stage 0408, the process ends.

The FIG. 4 illustrates a more general usage flown that the first notification and the second notification can be enabled or disabled separately. When both notifications are enabled, the notification during the call setup process, i.e. the first notification, and the notification after transition point, i.e. the second notification, should be different to be distinguished by user. The user can select the notification setting and the notification device. In the preferred embodiment of the present invention, the user disables the notification during the call setup process and enables the vibration notification after the transition point. So, the user can feel the transition point arrived when the phone starts to vibrate and move the phone to the user's ear and start to the conversation. Then, the present invention automatically stops the vibration when it detects the stop condition as described in stage 0407. In another embodiment of the present invention, the user enables a vibration notification during call setup process and disables the notification after the transition point. So, the user feels the vibration when phone is setting up the call, and feels vibration stop when the transition point arrived. So, the user can start the conversation when the phone stops vibrating. In yet another embodiment, both the first notification and the second notification are enabled and are in different style. Then, System 0100 stops the second notification when detecting the stop condition as described in stage 0407.

A call setup will end up in call connected or call dropped, i.e. success or fail. To distinguish whether the call is connected or is dropped, the preferred embodiment of present invention notifies the user in different ways. The different notification could be generated by different notification devices or by the same notification device but in different notification patterns, which is different in one or more ways selected from duration, strength, frequency, sequence, tempo, etc., or a combination of those.

### Determine the Stop Condition Smartly

To prevent accidentally stop the second notification, for example user puts the phone too close to his body, an embodiment of the present invention set a minimum notification duration for the second notification. So, user will still receive the second notification even if the proximity sensor is used as the only stop condition and the phone is close to his leg. For detecting more conditions, multiple sensors could be used to determine user's intention to talk, i.e. the stop condition. However, sometimes the user's intention is harder to determine, for example when user is running. In another embodiment of the present invention, it checks for user's movement before the second notification. If user is moving swiftly during call setup, the activity of movement becomes less reliable and it automatically changes to use the proximity sensor activity to determine the stop condition. Therefore, the present invention further detects one or more factors before the second notification and adjusts the weight of each stop activity when determine the user's intention to talk. For example, the present invention becomes less sensitive to or totally ignores an activity if the activity is detected before the second notification. For example, the microphone is ruled out if the environment is too noisy; proximity sensor is ruled out if something is something already block the phone; the gyroscope is ruled out if user is rotating, the touch sensor is ruled out if something is touching the sensor, etc. Therefore, the present invention further comprising automatically adjusting the weight of each activity in determining the user's intention to talk, wherein said weight is based upon one or more factors selected from the following group consists of quietness around the environment, user's movement related activity, user's orientation related activity, an object in proximity to the phone, and touching related activity. These factors may be determined during call setup process or before the second notification turned on.

### Notification Device Selection

In the preferred embodiment of the present invention, the mobile phone, i.e. system 0100, uses vibration, which is generated by a vibrator, to notify the user. However, several other notification devices can be used, for example a loud speaker, or light emitter, etc. The user can manually select the notification device or system 0100 automatically selects the notification device based on the ambient situation. For example, the user walks while making a phone call from a noise place to a quiet room, such as restaurant. An embodiment of the present invention detects the change of ambient condition and automatically changes the notification device from loud speaker to vibrator.

### Conclusion, Ramifications, and Scope

The present invention notifies the user the status of an originated call with a less distraction way. It prevents user from using the earpiece speaker and reduces distraction and the electromagnetic radiation absorption during the call setup process. The notification can be stopped automatically and naturally by the reaction that user moves or approaches the phone or speaks to the phone. The present invention is further able to select the best notification device automatically based on the ambient conditions and dynamically adjust the stop condition that indicate user's real intention or response to the notification.

Although the description above contains many specific details, these should not be construed as limiting the scope of the invention but as merely providing illustrations of some the possible embodiments of the invention.

Thus, the scope of the invention should be determined by the appended claims and their legal equivalents, rather than by the examples given.

I claim:

1. A method for a mobile phone to notify a user the connection status of an originated phone call, the method comprising:
selecting a called party;
conducting a setup process to establish the phone call to the called party; and
generating a notification in response to the end of the setup process or the start of an answer machine prompt message.

2. The method of claim 1, further comprising stopping the notification in response to one or more activities detected after starting the notification and the activities is selected from the following group consists of
detecting a sound related activity;
detecting a movement related activity;
detecting an orientation related activity;
detecting an object in proximity to the phone; and
detecting a touching related activity.

3. The method of claim 2, further comprising adjusting the weight of each activity in determining the user's intention to talk, wherein said weight is based upon one or more factors detected before starting the notification and said factor is selected from the following group consists of
quietness around the environment;
user's movement related activity;
user's orientation related activity;
an object in proximity to the phone; and
touching related activity.

4. The method of claim 1, further comprising stopping the notification in response to one or more activities detected after starting the notification by one or more sensors selected from the following group consists of
a microphone;
an accelerometer;
a gyroscope;
a proximity sensor; and
a touch sensitive device.

5. The method of claim 4, further comprising adjusting the weight of each activity for determining the user's intention to talk, wherein said weight is based upon one or more factors detected before starting the notification and said factor is selected from the following group consists of
quietness around the environment;
user's movement related activity;
user's orientation related activity;
an object in proximity to the phone; and
touching related activity.

6. The method of claim 1, further comprising stopping the notification by a time-out mechanism.

7. The method of claim 1, wherein said notification generated for the failure of setup process is different from the notification generated for the success of setup process.

8. The method of claim 1, wherein said notification includes a vibration or a sequence of vibration.

9. The method of claim 1, wherein the type of said notification is selected based on the ambient condition around the phone, wherein said ambient condition includes quietness, darkness, temperature, and in proximity to an object.

10. A mobile phone system for notifying a user the connection status of an originated phone call, the system comprising:
a dialer for selecting a called party;
a communication module for setting up a call to the called party; and
a device for generating a notification in response to the end of the call setting up or the start of a answer machine prompt message.

11. The system of claim 10, wherein said notification is stopped in response to one or more activities detected after starting the notification and the activity is selected from the following group consists of
detecting a sound related activity;
detecting a movement related activity;
detecting a orientation related activity;
detecting a object in proximity to the phone; and
detecting a touching related activity.

12. The system of claim 11, further comprising a module for adjusting the weight of each activity in determining the user's intention to talk, wherein said weight based upon one or more factors detected before starting the notification and said factor is selected from the following group consists of
quietness around the environment;
user's movement related activity;
user's orientation related activity;
an object in proximity to the phone; and
touching related activity.

13. The system of claim 10, wherein said notification is stopped in response to one or more activities detected after starting the notification by one or more sensors selected from the following group consists of
a microphone;
an accelerometer;
a gyroscope;
a proximity sensor; and
a touch sensitive device.

14. The system of claim 13, further comprising adjusting the weight of each activity in determining the user's intention to talk, wherein said weight based upon one or more factors detected before starting the notification and said factor is selected from the following group consists of
quietness around the environment;
user's movement related activity;
user's orientation related activity;
an object in proximity to the phone; and
touching related activity.

15. The system of claim 10, further comprising a time-out mechanism to stop the notification.

16. The system of claim 10, wherein said notification generated for the failure of the call setting up is different from the notification generated for the success of call setting up.

17. The system of claim 10, wherein the notification includes a vibration or a sequence of vibration

18. The system of claim 10, wherein the type of said notification is selected based on the ambient condition around the phone, wherein said ambient condition includes quietness, darkness, temperature, and in proximity to an object.
